(19) United States
(12) Patent Application Publication
(10) Pub. No.: US 2009/0045612 A1
(43) Pub. Date: Feb. 19, 2009

(54) Flameless method to open a cold gas inflator burst disk

(75) Inventors: Matt Cox, Centerville, UT (US); David J. Green, Brigham City, UT (US)

Correspondence Address: Sally J. Brown;AUTOLIV ASP, INC., 3350 Airport Road, Ogden, UT, 84405, US

(73) Assignee: Autoliv ASP, Inc.

(21) Appl. No.: 11/893,508

(22) Filed: Aug. 15, 2007

(51) Int. Cl. B60R 21/26

(52) U.S. Cl. 280/741

(57) ABSTRACT

An inflator including a chamber that houses a quantity of inflation gas. The chamber is sealed by a burst disk. A punch is also added. The punch is positioned proximate the burst disk. An initiator is also added to the inflator. The initiator includes a cylinder storing a quantity of ignitable material. The cylinder also includes a folded wall with a closed end, wherein upon ignition of the ignitable material, the folded wall unfolds causing the punch to fail the burst disk. The inflator may also be designed such that the folded wall and the closed end retain all of the products formed by ignition of the ignitable material within the cylinder. The inflator may also be designed such that actuation of the initiator does not cause a flash.

### BACKGROUND OF THE INVENTION

Airbag and airbag systems have been used on motor vehicles for many years. These systems have been credited with saving many lives. In general, these airbag systems are designed such that during a crash, an airbag will be deployed and inflated into the interior of the vehicle. The inflated airbag is positioned in a location that protects the vehicle occupant during a crash. In other words, the inflated airbag is positioned so that the occupant will impact the airbag rather than the steering wheel, the dashboard, or other surfaces of the vehicle interior. A variety of different types of airbag systems have been known and used in the art including steering wheel airbag systems, side curtain airbag systems, and passenger airbag systems.

In order to inflate and deploy the airbag, airbag systems generally include an inflator. One type of inflator that is currently used with side curtain airbag systems is the so-called “cold gas” inflator. The cold gas inflator is an inflator that houses a large quantity of inflation gas within a sealed chamber. In the event of an accident, the chamber is unsealed so that the gas can flow out of the inflator. As the gas flows out of the inflator, it is channeled into the airbag. It is this influx of inflation gas into the airbag that inflates the airbag.

In some previously known “cold gas” type inflators, a burst disk is used to seal the chamber that houses the inflation gas. This burst disk is generally positioned over an opening in the chamber. The inner (inside) surface of the burst disk experiences the high pressures associated with the gas stored in the chamber. The outer (outside) surface of the burst disk is not generally pressurized and is maintained at or near ambient pressure.

During deployment of the inflator, this burst disk will be ruptured/failed by either (1) shooting a projectile through the burst disk or (2) using the gas output from the initiator to “blow” a hole in the burst disk. It should be noted that such methods of failing the burst disk all operate to rupture the disk from outside of the chamber, i.e., from the un-pressurized outside of the chamber. However, when the burst disk is ruptured from the un-pressurized side of the chamber, there is a tendency for the inflator to emit a “flash.” A “flash” is an instant of flaming that often occurs when the initiator deploys. This flashing (or flaming) of the inflator is undesirable. Further, when the chamber is unsealed from the un-pressurized side of the burst disk, fragments of the burst disk/initiator may be formed. These fragments should be retained in the inflator to prevent them from being released into the airbag cushion.

Having an initiator flash is undesirable for a variety of reasons. Specifically, many automobile manufacturers will not accept inflator systems that have a flash.

Accordingly, there is a need in the art for a new type of inflator that does not emit a flash when the inflator is unsealed from the un-pressurized end. There is a further need in the art for a new type of inflator that does not produce fragments when the burst disk is ruptured. Such a device is disclosed herein.

### BRIEF SUMMARY OF THE INVENTION

An inflator is disclosed. The inflator comprises a chamber housing a quantity of inflation gas, the chamber being sealed by a burst disk. A punch is also added to the inflator. The punch IS positioned proximate the burst disk. An initiator is used with the inflator. The initiator comprises a cylinder storing a quantity of ignitable material, the cylinder including a folded wall with a closed end, wherein upon ignition of the ignitable material, the folded wall unfolds, or at least partially unfolds, causing the punch to fail the burst disk. The folded wall and the closed end retain all of the products formed by ignition of the ignitable material within the cylinder. One or more leads may be added to the initiator. Overmolding may also be positioned over the leads.

The punch is held within the inflator after deployment of the inflator. In other embodiments, the punch is positioned proximate the fold. In further embodiments, the inflator is designed such that upon ignition of the ignitable material, the folded wall unfolds and pushes the punch into contact with the burst disk, wherein the contact between the punch and the burst disk operates to fail the burst disk.

In some embodiments, the folded wall comprises a fold that folds the wall inward. The folds may remain in the wall even after the wall is unfolded.

A method of preventing flash in an inflator is also disclosed. This method may include the step of obtaining an inflator comprising a chamber housing a quantity of inflation gas, the chamber being sealed by a burst disk, a punch positioned proximate the burst disk, an initiator comprising a cylinder storing a quantity of ignitable material, and the cylinder including a folded wall with a closed end. The method may also include the step of igniting the initiator, wherein upon ignition of the ignitable material, the folded wall unfolds (or at least partially unfolds) causing the punch to fail the burst disk, wherein actuation of the initiator does not cause a flash.

As noted above, the present embodiments relate to an inflator. The inflator includes an outer wall that surrounds a chamber. The chamber houses a quantity of inflation gas. The gas is maintained within the chamber at a high pressure. The chamber is a sealed chamber. In general, a burst disk is used to seal the chamber.

The inflator also includes an initiator. The initiator includes a quantity of ignitable material and one or more leads. The initiator is a device that is capable of activating the inflator and instigating deployment. In other words, in the event of an accident or a crash, a signal will be sent to the initiator, via the leads. This signal operates to ignite the ignitable material. A punch is also added to the inflator. The punch is positioned proximate the burst disk. The punch is a device that is capable of failing the burst disk. More specifically, if the punch is brought into contact with the burst disk, the punch fails or ruptures the burst disk.

The initiator includes a cylinder that houses the quantity of ignitable material. The cylinder is a closed, airtight system such that the ignitable material cannot escape the cylinder. When the ignitable material is ignited, this ignition/combustion event produces products and/or by-products; however, all products and/or by-products formed during the combustion/ignition of the ignitable material are maintained within the cylinder.

The cylinder includes a folded wall. As its name suggests, the folded wall includes a fold. This fold is a bend in the wall. In some embodiments, the wall folds inward forming a cavity.

Activation (actuation) of the initiator causes the wall to unfold. Specifically, when the initiator is activated, the ignitable material is ignited/combusted. Such ignition rapidly increases the pressure within the cylinder. This increase in pressure presses against the closed end of the cylinder. In response to the increased pressure, the closed end advances by moving away from the leads. In order to accommodate the movement of the closed end, the folds partially unfold. As the cylinder expands during the unfolding process, the punch is moved into contact with the burst disk. More specifically, as the cylinder expands, the folded wall unfolds and causes the punch to fail the burst disk.

When the initiator is deployed, the wall remains wholly integral such that no holes, apertures, or openings are formed. Rather, the folded wall retains all of the products (or by-products) formed by ignition of the ignitable material within the cylinder. Because the products are all retained within the cylinder, the products or by-products cannot escape the initiator and are not allowed to enter the airbag, such that no flash is visible.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a longitudinal cross-sectional view of an inflator according to the present embodiments;

FIG. 2 is a perspective, longitudinal cross-sectional view of an initiator that may be used as part of the inflator of FIG. 1;

FIG. 2A is a plan cross-sectional view of the initiator of FIG. 2 showing the unfolding of the folded wall in phantom lines;

FIG. 2B is a cross-sectional view that shows the interaction between the punch and the initiator, wherein the initiator is in the undeployed configuration;

FIG. 2C is a cross-sectional view that shows the interaction between the punch and the initiator, wherein the initiator is in the deployed configuration;

FIG. 3 is cross-sectional view of the embodiment of FIG. 1 which shows the deployment of the inflator; and

FIG. 4 shows examples of different types of cutting portions that may be used as part of the punch that operate to fail the burst disk.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

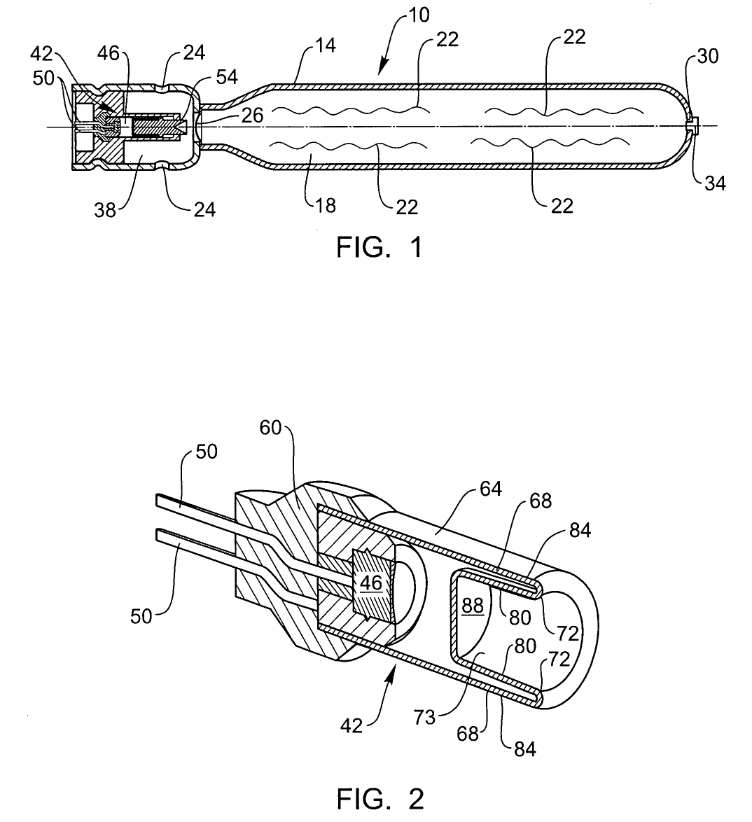

Referring now to FIG. 1, an embodiment of an inflator 10 is illustrated. The inflator 10 may be a “cold gas” type inflator. However, other types of inflators, including hybrid inflators, may also be used. The inflator 10 includes an outer wall 14 that surrounds a chamber 18. The chamber 18 houses a quantity of inflation gas 22. The gas 22 is maintained within the chamber 18 at a high pressure. It is for this reason that the inflator 10 is referred to as a pressure vessel, because the inflation gas 22 is housed at a high pressure. The inflation gas 22 is designed such that it may be used to inflate an airbag. In other words, when the inflator is deployed (as described herein), the inflation gas 22 will be channeled out of the inflator 10, via venting openings 24, into an airbag (not shown). The influx of the inflation gas 22 into the airbag operates to inflate the airbag.

In order to hold the inflation gas 22 within the chamber 18 prior to deployment, the chamber 18 is a sealed chamber. In general, a burst disk 26 is used to seal the chamber 18. As is described in greater detail herein, the burst disk 26 is ruptured during deployment to allow the inflation gas 22 to exit the chamber 18. In some embodiments, the burst disk 26 may also be designed to vent out the gas 22 out of the chamber 18 in the event of over-pressurization.

In some embodiments, the chamber 18 may include a filling opening 30 that is sealed by a plug 34. The plug 34 provides an airtight seal to the opening 30 to ensure that the inflation gas 22 is maintained within the chamber 18 at a high pressure. The presence of the opening 30 is designed to facilitate the manufacturing process. Specifically, when the inflator 10 is constructed, it is made as an empty container, i.e., without having any inflation gas 22. The inflation gas 22 is later added to the chamber 18 via the opening 30. Once the gas 22 is added to the chamber 18, the opening 30 is sealed via the plug 34.

In some embodiments, the inflator 10 may also include a diffuser 38. The diffuser 38 may be positioned such that during deployment, the inflation gas 22 will flow through the diffuser 38 prior to exiting the inflator 10. In some embodiments, the diffuser 38 may be designed to filter the inflation gas 22.

The inflator 10 also includes an initiator 42 that includes a quantity of ignitable material 46 and one or more leads 50. The initiator 42 is a device that is capable of activating the inflator 10 and instigating deployment. In other words, in the event of an accident or a crash, a signal will be sent to the initiator 42, via the leads 50. This signal operates to activate the initiator 42. Such activation generally involves igniting the ignitable material 50 in the initiator 42.

A punch 54 is also added to the inflator 10. The punch 54 is positioned proximate the burst disk 26. In the embodiment of FIG. 1, the punch 54 is positioned interior of the diffuser 38. Other locations, positions, and/or configurations for the punch 54 may also be used. The punch is a cutter, bar, blade, or other device that is capable of failing the burst disk 26. Any shape for the punch 54 may be used. More specifically, if the punch 54 is brought into contact with the burst disk 26, the punch 54 fails or ruptures the burst disk 26. As will be explained in greater detail herein, activation of the initiator 42 causes the punch 54 to fail the burst disk 26. Once the burst disk 26 has been failed, the inflation gas 22 will escape the chamber 18 and will be channeled into the airbag.

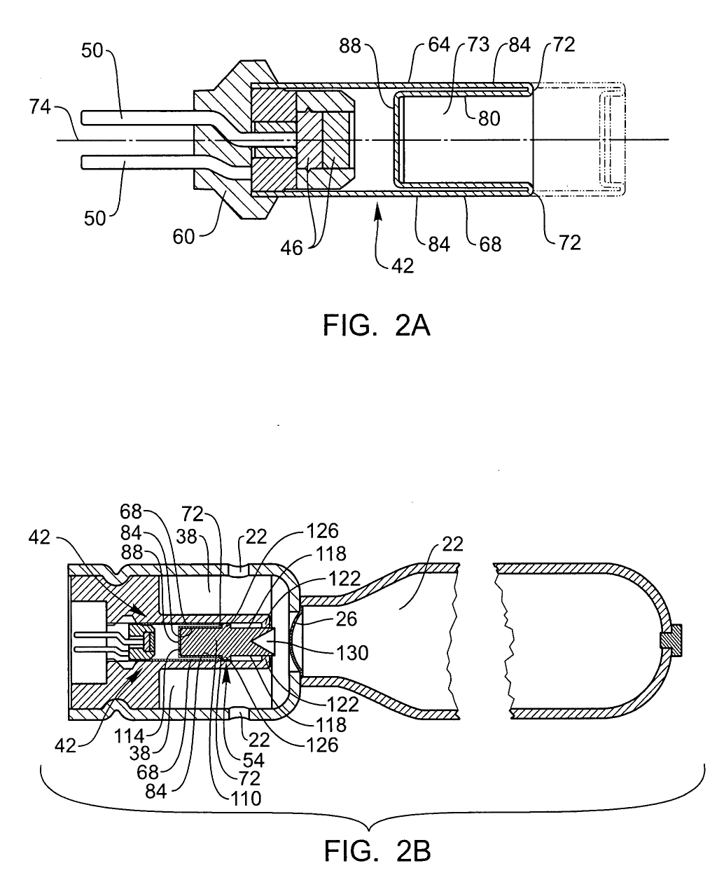

Referring now to FIGS. 2 and 2A, the initiator 42 will be described in greater detail. FIG. 2A is a longitudinal cross-sectional plan view that illustrates the initiator 42 whereas FIG. 2 is a perspective, longitudinal cross-sectional view. As shown in FIGS. 2 and 2A, the initiator 42 may additionally include overmolding 60 that engages and/or surrounds the leads 50. This overmolding 60 may be made of plastic or other similar materials. The leads 50 may extend through all or a portion of the overmolding 60.

The initiator 42 may include a cylinder 64 that houses the quantity of ignitable material 46. The cylinder 64 is a closed, airtight system such that the ignitable material 46 cannot escape the cylinder 64. When the ignitable material 46 is ignited, this ignition/combustion event produces products and/or by-products; however, all products and/or by-products formed during the combustion/ignition of the ignitable material 46 are maintained within cylinder 64 and do not contact the inflation gas 22.

The cylinder 64 includes a folded wall 68. The cylinder 64 has both a retracted configuration and an extended configuration. In FIG. 2A, the retracted configuration is shown in solid lines whereas the extended configuration is shown in phantom lines. (The retracted configuration is the configuration shown in FIG. 1.) Prior to deployment, the folded wall 68 is in the retracted configuration. When the initiator activates (as part of the deployment of the inflator), the wall 68 is converted from the retracted configuration to the extended configuration.

As its name suggests, the folded wall 68 includes one or more folds 72. These folds 72 are present when the wall 68 is in the retracted configuration (as shown in FIG. 2A). More than one fold 72 may be included. As shown in FIGS. 2 and 2A, and for ease of understanding, only one fold 72 is illustrated. The wall 68 includes two separate portions, a first wall portion 80 and a second wall portion 84. The first and second wall portions 80, 84 are separated by the fold 72. The fold 72 may comprise bends in the wall 68.

As shown in FIGS. 2 and 2A, the wall 68 has been folded inwardly along the fold 72. An “inward” fold means that, as a result of the fold, all or a portion of the first wall portion 80 is positioned inward of the second wall portion 84. The term inward of the second wall portion means that the first wall portion 80 is positioned closer to the center line 74 (as shown in FIG. 2A) of the initiator 42 than is the second wall portion 84. The center or longitudinal axis of the initiator is represented by center line 74.

When the folded wall 68 is folded at the fold 72, the wall 68 is folded inward on itself. As such, a cavity 73 may be formed by the folded wall. The cavity 73 is positioned interior of the second wall portion 84.

As noted above, activation (actuation) of the initiator 42 causes the wall 68 to unfold. This unfolding converts the wall 68 from the retracted configuration to the extended configuration. This “unfolding” process will now be described in greater detail. Specifically, when the initiator 42 is activated, the ignitable material 46 is ignited/combusted. Such ignition rapidly increases the pressure within the cylinder 64. This increase in pressure presses against the closed end 88 of the cylinder 64. (The closed end 88 is attached to/part of the wall 68). In response to the increased pressure, the closed end 88 advances by moving away from the leads 50. As the closed end 88 moves, the volume of the cylinder 64 expands. In order to accommodate the movement of the closed end 88, the folds 72 partially unfold. This means that all or a portion of the first wall portion 80 moves and becomes parallel (or substantially parallel) to the second wall portion 84. As the first wall portion 80 becomes parallel to the second wall portion 84, the cylinder 64 extends outward and becomes larger and/or longer. It is this extending of the first wall portion 80 into a position that is parallel or substantially parallel that moves the wall 68 into the extended configuration.

It should be noted that in some embodiments, the extended configuration extends the wall 68 entirely, such that there is no longer a fold 72 remaining in the wall 68. However, in other embodiments, such as the embodiment shown in FIG. 2A, the wall 68 still retains one or more folds 72, even after the wall 68 has been “unfolded” into the extended configuration. However, regardless of whether a fold 72 remains in the extended configuration, the cylinder 64 in the extended configuration has a much greater volume and at least a portion of the first wall portion 80 is co-linear (or substantially co-linear) to the second wall portion 84.

Referring now to FIGS. 2B and 2C, the interaction between the initiator 42 and the punch 54 will now be described. FIG. 2B shows the initiator 42 in the undeployed configuration whereas FIG. 2C shows the initiator 42 in the deployed configuration. As shown in FIGS. 2B and 2C, the punch 54 may include a cylindrical portion 110 that may be positioned interior of the first wall portion 80 (shown in FIG. 2A). A back end 114 of the cylindrical portion 110 may abut and/or be positioned adjacent to the initiator's closed end 88.

A housing 118 having a shoulder 122 may surround the cylindrical portion 110. The cylindrical portion 110 may also include a retaining feature 126. As shown in FIG. 2B, the retaining feature 126 may be positioned proximate the fold 72 when the initiator 42 is in the undeployed configuration. However, as shown in FIG. 2C, when the initiator 42 is deployed, the punch 54 will be moved such that the retaining feature 126 contacts and/or engages the shoulder 122. The contact/engagement between the shoulder 122 and the retaining feature 126 limits the movement of the punch 54 and ensures that the punch 54 does not become a projectile.

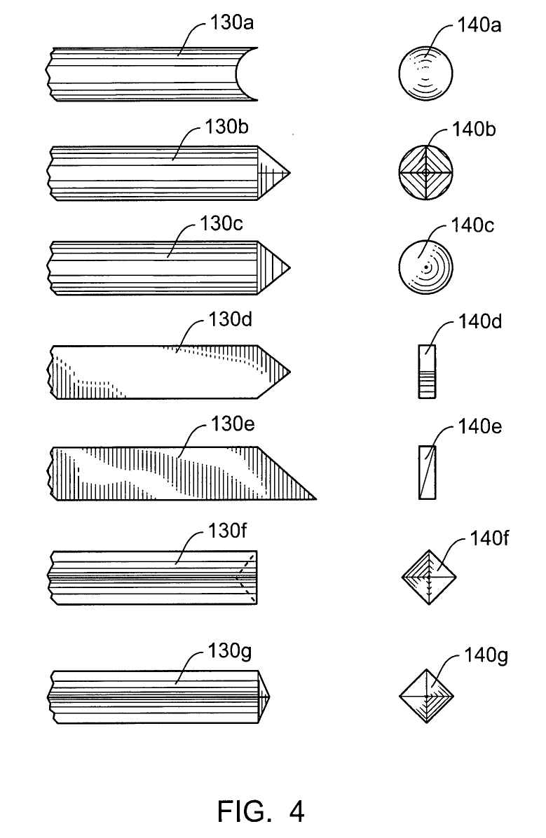

The punch 54 may also comprise a cutting portion 130. This cutting portion 130 may be positioned opposite of the back end 114. When the initiator 42 is deployed and the closed end 88 is moved, such movement of the end 88 pushes against the back end 114 and causes the back end 114 to move towards the chamber 18. As the punch 54 is moved toward the burst disk 26, the cutting portion 130 will contact the burst disk 26 and cause the burst disk 26 to rupture or fail. It should be noted that additional types of cutting portions that may be used as part of the punch 54 are shown in FIG. 4.

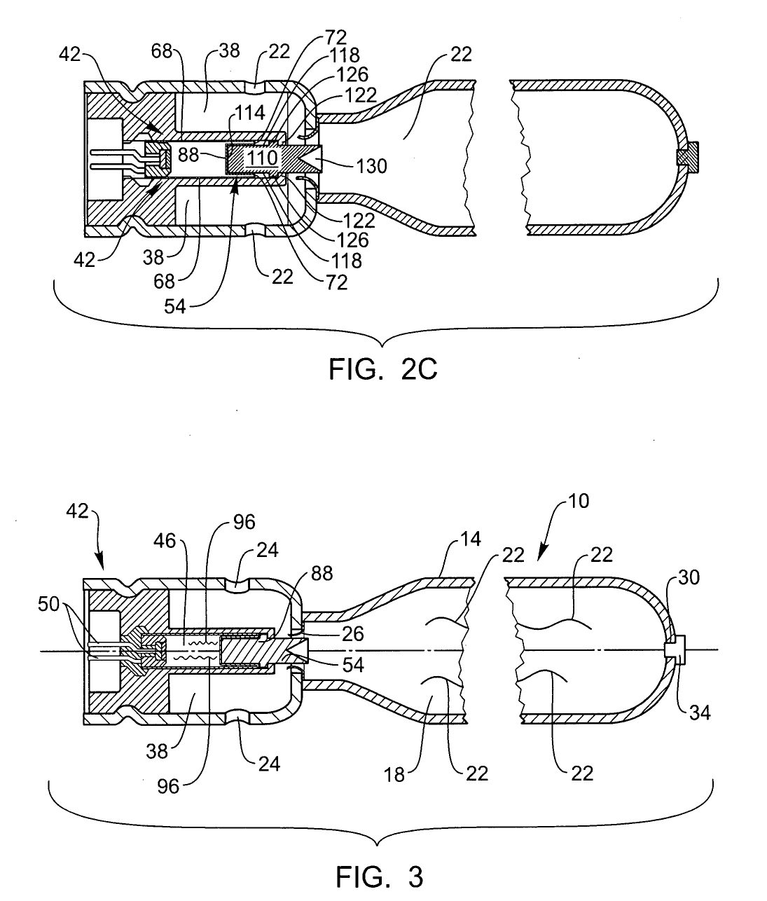

Referring now to FIG. 3, a slightly enlarged, partially broken-away cross-sectional view of the inflator 10 that is similar to FIG. 1 is illustrated. The main difference between FIG. 1 and FIG. 3 is that in FIG. 3, the inflator 10 is shown after the initiator 42 has been actuated and deployed in the manner described above. As noted above, as the initiator 42 moves from the retracted configuration to the extended configuration, the cylinder 64 (shown in FIG. 1) expands in length. As the cylinder 64 expands, the wall 68 (shown in FIG. 2) contacts the punch 54. More specifically, as the cylinder 64 expands, the folded wall 68 unfolds and causes the punch 54 to fail the burst disk 26. The wall 64 pushes the punch 54 into contact with the burst disk 26 such that a hole or rupture is formed in the burst disk 26. In some embodiments, the wall 68, when it unfolds, contacts the punch 54 and moves the punch 54 into contact with the burst disk 26. In other embodiments, the unfolding of the wall 68 causes the closed end 88 to contact the punch 54 and move the punch 54 into contact with the burst disk 26. In further embodiments, both the end 88 and the wall 68 move the punch 54 into the contact with the burst disk 26 when the wall 68 unfolds.

Embodiments may be constructed such that when the punch 54 fails the burst disk 26, the punch 54 simply punctures the disk 26 such that no piece of the burst disk 26 is detached or separated. Of course, if a piece of the ruptured disk 26 does separate or become detached, the diffuser 38 may capture/retain this piece. Accordingly, no piece of the ruptured burst disk 26 is allowed to enter the airbag.

In the embodiment of FIG. 3, the inflator 10 is designed such that even after the punch 54 fails the burst disk 26, the punch 54 is retained within the inflator 10. Specifically, when the punch 54 is moved, there may be, incident to this movement, some deformation, bending of the material, etc. (Of course, other embodiments may be designed in which there is no such deformation/bending, etc.) However, after the punch 54 has been moved, the punch 54 will not be retracted or returned to its original position. Rather, the punch 54 has sufficient structural integrity/strength such that it remains in the deployed position (i.e., the position of FIG. 2C), even after the initiator 42 has been deployed. Also, because the punch 54 remains in the deployed position, the punch 54 remains and/or is maintained within the inflator.

Once the burst disk 26 has been failed, the chamber 18 is no longer a sealed chamber 18. Rather, once the burst disk 26 is failed, the inflation gas 22 which was stored under high pressure within the chamber 18 escapes the chamber 18, flows through the diffuser 38, and then exits the inflator 10 via the openings 24.

As noted above, when the initiator 42 is deployed, the wall 68 remains wholly integral such that no holes, apertures, or openings are formed. Rather, the folded wall 68 retains all of the products (or by-products) formed by ignition of the ignitable material 46 (shown in FIG. 3) within the cylinder 64. The products and by-products (which may include heat, flames, and/or gas) formed during ignition of the ignitable material 46 are referred to as “products” and are represented by reference number 96. Because the products are all retained within the cylinder 64, the products 96 cannot escape the initiator 42 and are not allowed to enter the airbag or directly contact the inflation gas 22. Similarly, as all of the products 96 are housed, no flash is formed when the initiator 42 deploys.

Because all of the products 96 are self-contained by the cylinder 64/wall 68, no visible flash or hot particles escape the initiator 42 when the ignitable material 46 is ignited. Rather, the energy associated with ignition of the ignitable material 46 creates pressure that presses against the closed end 88. By pressing against the closed end 88, the energy associated with initiation is converted to work that operates to move the closed end 88. As explained above, this movement of the closed end 88 causes the fold 72 to (partially or fully) unfold and causes the punch 54 to move and fail the burst disk 26.

FIG. 4 shows examples of cutting portions that may be used as part of the punch 54 (shown in FIG. 1). These cutting portions, which are designated as cutting portions 130a through 130g, may be used in place of the cutting portion 130 shown above. Also shown in FIG. 4 are the corresponding cut patterns that are formed in the burst disk 26 (not shown in FIG. 3) when these cutting portions 130a-130g are used. These cut patterns are designated as 140a-140g. Of course, the disclosure of FIG. 4 is given as exemplary types of cutting portions. Other types of cutting portions may be used as part of the punch 54.

Referring now to all of the figures generally, the present embodiments also relate to a method for preventing flash in an inflator. This method may involve the steps of obtaining an inflator 10. As explained above, the inflator 10 comprises a chamber 18 housing a quantity of inflation gas 22, the chamber 18 being sealed by a burst disk 26, a punch 54 positioned proximate the burst disk 26, an initiator 42 comprising a cylinder 64 storing a quantity of ignitable material 46, the cylinder 64 including a folded wall 68 with a closed end 88. The method may also include the step of igniting the initiator 42, wherein upon ignition of the ignitable material 46, the folded wall 68 unfolds causing the punch 54 to fail the burst disk 26, wherein actuation of the initiator 42 does not cause a flash.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An inflator comprising:
a chamber housing a quantity of inflation gas, the chamber being sealed by a burst disk;
a punch positioned proximate the burst disk;
an initiator comprising a cylinder storing a quantity of ignitable material, the cylinder including a folded wall with a closed end, wherein upon ignition of the ignitable material, the folded wall unfolds causing the punch to fail the burst disk.

2. The inflator as in claim 1 wherein the folded wall and the closed end retains all of the products formed by ignition of the ignitable material within the cylinder.

3. The inflator as in claim 1 wherein actuation of the initiator does not cause a flash.

4. The inflator as in claim 1 wherein upon ignition of the ignitable material, the folded wall unfolds and pushes the punch into contact with the burst disk, wherein the contact between the punch and the burst disk operates to fail the burst disk.

5. The inflator as in claim 1 wherein the punch is held within the inflator after deployment of the inflator.

6. The inflator as in claim 1 wherein the initiator comprises one or more leads, wherein overmolding is positioned about the leads.

7. The inflator as in claim 1, wherein the folded wall comprises a fold that folds the wall inward on itself, thereby forming a cavity.

8. The inflator as in claim 7 wherein one or more folds remain in the wall after the wall is unfolded by ignition of the initiator.

9. The inflator as in claim 7 wherein the punch is positioned proximate the fold.

10. The inflator as in claim 1 wherein the unfolding of the wall causes a first wall portion to become substantially co-linear to a second wall portion.

11. An initiator for use with an inflator having a chamber housing a quantity of inflation gas housed in a chamber sealed by a burst disk, the initiator comprising a cylinder storing a quantity of ignitable material, the cylinder including a folded wall with one or more folds and a closed end, wherein upon ignition of the ignitable material, the folded wall at least partially unfolds and causes a punch to fail the burst disk.

12. The initiator as in claim 11 wherein the folded wall and the closed end retains all of the products formed by ignition of the ignitable material within the cylinder.

13. The initiator as in claim 11 wherein actuation of the initiator does not cause a flash.

14. A method of preventing flash in an inflator, comprising:
obtaining an inflator comprising a chamber housing a quantity of inflation gas, the chamber being sealed by a burst disk, a punch positioned proximate the burst disk, an initiator comprising a cylinder storing a quantity of ignitable material, the cylinder including a folded wall with a closed end; and
igniting the initiator, wherein upon ignition of the ignitable material, the folded wall unfolds causing the punch to fail the burst disk, wherein actuation of the initiator does not cause a flash.

15. The method as in claim 14 wherein the folded wall and the closed end retains all of the products formed by ignition of the ignitable material within the cylinder.
